(19) United States
(12) Patent Application Publication
(10) Pub. No.: US 2012/0221839 A1
(43) Pub. Date: Aug. 30, 2012

(54) Memory Initialization method and Serial Peripheral Interface Using the Same

(76) Inventors: Wei-Ju Chen, New Taipei City (TW); Zhemin Lin, New Taipei City (TW)

(21) Appl. No.: 13/118,590

(22) Filed: May 31, 2011

(30) Foreign Application Priority Data
Feb. 25, 2011 (TW) 100106390

(51) Int. Cl. G06F 9/00

(52) U.S. Cl. 713/1

(57) ABSTRACT

A memory initialization method for writing a system management firmware and a Basic Input/output system (BIOS) in a memory of an information system is disclosed. The memory initialization method includes writing the BIOS in the memory, arranging a Read-Only Memory (ROM) hole in the memory, and writing the system management firmware in the ROM hole.

### BACKGROUND OF THE INVENTION

1. Field of the Invention

The present invention relates to a memory initialization method and related serial peripheral interface using the same, and more particularly, to a memory initialization method which writes a system management firmware in a ROM hole, and related serial peripheral interface using the same.

2. Description of the Prior Art

During a manufacturing process of a server, it is necessary to write a management firmware in a memory to provide functionalities such as system access, remote control, hardware monitoring, power management, etc. For example, Intel server architecture employs Active Management Technology (AMT), wherein the management firmware is called a Management Engine (ME). Since the ME is has to be stored via an extra serial peripheral interface (SPI), extra costs for the SPI circuit is incurred. Furthermore, an ME which is dependent on SPI for storage cannot be readily updated. As a solution, Intel designs a Flash Image Tool (FIT), for encapsulating the ME and a Basic Input/output system (BIOS) in a same binary file, and for an integration thereof into a same serial peripheral interface circuit.

Specifically, please refer to FIG. 1, which is a schematic diagram of an image file 10 of the Intel FIT encapsulation. The image file 10 includes an ME 104, a primary BIOS 108 and related supporting functionalities 100, 102, 112, 114. The image file 10 occupies 8 MB memory space, wherein segments 106, 110 are ROM holes, which are fixed-length blank regions within a consecutive memory space for storing replaceable binary components. In FIG. 1, the 8 MB memory space in the image file 10 is not fully utilized, and the segments 105, 106, 110 are idle.

Additionally, since the image file 10 is has to be written using Intel proprietary software or chip burning device, it is not conducive for the use of end-users, or BIOS updating requirements of Original Equipment Manufacturer (OEM) software or independent BIOS Vendor (IBV) software.

Therefore, it has become the focus of the industry to provide end-users with a low-cost, convenient burning solution for server management firmware.

### SUMMARY OF THE INVENTION

It is therefore a primary objective of the claimed invention to provide a memory initialization method and a serial peripheral interface.

An embodiment of the invention discloses a memory initialization method for writing a system management firmware and a BIOS in a memory of an information system. The memory initialization method includes writing the BIOS in the memory, arranging a ROM hole in the memory, and writing the system management firmware in the ROM hole.

An embodiment of the invention further discloses a serial peripheral interface, stored in a memory of an information system. The serial peripheral interface includes a BIOS, and a system management firmware.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an image file of an Intel Flash Image Tool encapsulation.

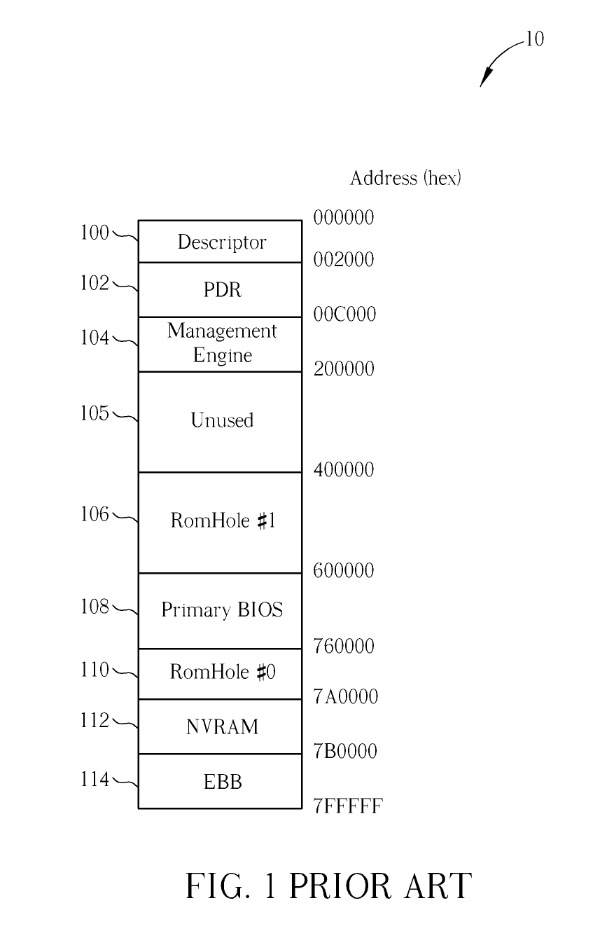

FIG. 2 is a schematic diagram of a memory initialization process according to an embodiment of the invention.

FIG. 3 is a schematic diagram of a memory configuration generated by the memory initialization process shown in FIG. 2.

### DETAILED DESCRIPTION

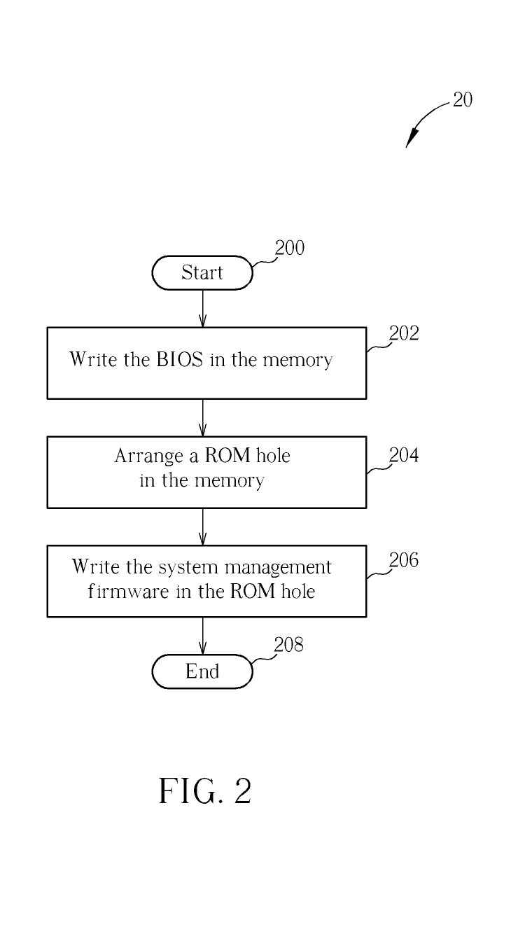

Please refer to FIG. 2, which is a schematic diagram of a memory initialization process 20 according to an embodiment of the invention. The memory initialization process 20 is utilized for writing a Basic Input/output System (BIOS) and a system management firmware in a memory of an information system. The memory initialization process 20 includes the following steps:

Step 200: Start.

Step 202: Write the BIOS in the memory.

Step 204: Arrange a ROM hole in the memory.

Step 206: Write the system management firmware in the ROM hole.

Step 208: End.

In short, to solve issues of the prior art, such as certain regions of the image file 10 being idle, and inconveniences for the end-user due to a requirement to write the image file 10 using Intel proprietary software or chip burning devices, etc., the memory initialization process 20 writes the system management firmware, e.g. a Management Engine (ME), in reserved ROM holes in the memory, to reduce a memory space occupied by the image file. Since the memory initialization process 20 may be performed via Original Equipment Manufacturer (OEM) software or independent BIOS Vendor (IBV) software, not limited to Intel proprietary software or chip, it helps lower manufacturing costs and facilitates end-users usage requirements.

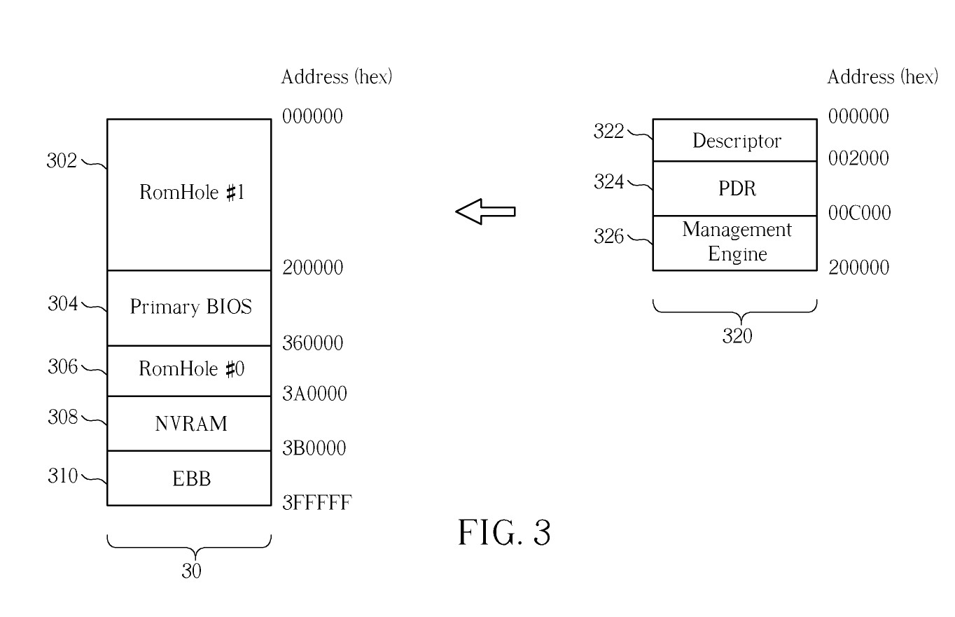

Specifically, please refer to FIG. 3, which is a schematic diagram of a memory configuration 30 generated by the memory initialization process 20. The memory configuration 30 is a result generated by an OEM software or IBV software performing Steps 202 and 204. Next, a BIOS (304) and a system management firmware (326) are integrated into a same serial peripheral interface (SPI) via further writing a binary file 320 into a ROM hole 302. In comparison with the image file 10 generated by Intel Flash Image Tool (FIT) software, the required memory space of the memory configuration 30 is reduced from 8 MB to 4 MB. Note that, the binary file 320 includes file headers (322, 324) generated by FIT and an ME 326, and may be generated via dissecting a first 2 MB in the image file 10.

For an information system, e.g. a server, the BIOS and system management firmware needs to be constantly updated during the manufacturing and testing process. Therefore, the system management firmware, e.g. the ME 326 shown in FIG. 3, supports updating BIOS and system management firmware via IBV software or OEM software. Furthermore, to prevent update failure, the system management firmware also supports a disaster recovery functionality for the BIOS.

On the other hand, the memory configuration 30 is a serial peripheral interface (SPI), which integrates a BIOS and a system management firmware, and embeds the system management firmware utilizing ROM holes reserved by OEM software or IBV software to save the memory space occupied by the information system.

In the prior art, the system management firmware has to be stored via an additional serial peripheral interface, which incurs extra circuits and costs. Even though Intel provides FIT, the image file 10 encapsulating the BIOS and the system management firmware contains certain unused segments, which is a waste of memory space for information systems such as servers, etc. Comparatively, the memory initialization process 20 of the invention utilizes ROM holes reserved by OEM software or IBV software to embed the system management firmware, which is a more economic way to integrate the BIOS and the system management firmware into a same serial peripheral interface. Furthermore, execution of the memory initialization process 20 is not limited to software or chip burners provided by a specific vendor. Instead, generic OEM software or IBV software may be used, thus facilitating the use of end-users.

To sum up, the invention utilizes ROM holes reserved by OEM or IBV software to embed the system management firmware, thus reducing the occupied memory space, and provides a more economic solution to integrate BIOS and system management firmware into a same serial peripheral interface.

Those skilled in the art will readily observe that numerous modifications and alterations of the device and method may be made while retaining the teachings of the invention.

What is claimed is:

1. A memory initialization method for writing a system management firmware and a basic input/output system (BIOS) in a memory of an information system, comprising:
writing the BIOS in the memory;
arranging a ROM hole in the memory; and
writing the system management firmware in the ROM hole.

2. The memory initialization method of claim 1, wherein the information system is a server.

3. The memory initialization method of claim 1, wherein the system management firmware supports updating the BIOS via an independent BIOS vendor (IBV) software or an original equipment manufacturer (OEM) software.

4. The memory initialization method of claim 1, wherein the system management firmware supports updating the system management firmware via an independent BIOS vendor (IBV) software or an original equipment manufacturer (OEM) software.

5. The memory initialization method of claim 1, wherein the system management firmware supports a disaster recovery functionality for the BIOS.

6. A serial peripheral interface (SPI) stored in a memory of an information system, the SPI comprising:
a Basic Input/output System (BIOS); and
a system management firmware.

7. The SPI of claim 6, wherein the information system is a server.

8. The SPI of claim 6, wherein the system management firmware supports updating the BIOS via an independent BIOS Vendor (IBV) software or an Original Equipment Manufacturer (OEM) software.

9. The SPI of claim 6, wherein the system management firmware supports updating the system management firmware via an independent BIOS Vendor (IBV) software or an Original Equipment Manufacturer (OEM) software.

10. The SPI of claim 6, wherein the system management firmware supports a disaster recovery functionality for the BIOS.
